(19) United States
(12) Patent Application Publication
(10) Pub. No.: US 2006/0269372 A1
(43) Pub. Date: Nov. 30, 2006

(54) Twist drill

(75) Inventor: Yasushi Goshima, Toyama (JP)

Correspondence Address: VENABLE LLP, P.O. BOX 34385, WASHINGTON, DC, 20043-9998, US

(73) Assignee: NACHI-FUJIKOSHI CORP., Toyama-shi (JP)

(21) Appl. No.: 11/440,470

(22) Filed: May 25, 2006

(30) Foreign Application Priority Data
May 30, 2005 (JP) 2005-156641

(51) Int. Cl. B23B 51/00

(52) U.S. Cl. 408/230

(57) ABSTRACT

A twist drill has a pair of concave-shaped main cutting edges continuous outwardly to respective center cutting edges, and a pair of corner cutting edges receding at an angle from the outer ends of the respective main cutting edges with respect to a drill rotation direction. Respective ends of the concave-shaped main cutting edges are situated on a straight line almost parallel to a plane passing through a drill axis. These cutting edges have a function of minimizing wear and chipping of corner portions and damage to leading edges in a drilling operation using no cutting oil, or a drilling operation wherein a very small amount of cutting oil is sprayed to the drill, or in a drilling operation on relatively hard steel. They also have a function of facilitating breaking of cut chips into pieces during a drilling operation using cutting oil and during a drilling operation on steel of relatively low hardness such as general structural rolled steels and low carbon steels.

### BACKGROUND OF THE INVENTION

The present invention relates to a twist drill that is capable of a drilling operation without using cutting oil or a drilling operation with spraying of a very small amount of cutting oil to the drill and which may need no oil hole. This twist drill has a shape of cutting edges that, during a drilling operation, minimizes wear of corner portions and breaks chips of material being formed into small pieces.

One example of a conventional twist drill, which can perform a drilling operation without using cutting oil or a drilling operation with spraying of a very small amount of cutting oil to the drill and which may require no oil hole, is shown in FIG. 3. FIG. 3(a) is a plan view of a tip portion of the twist drill, FIG. 3(b) is a side view as viewed in a direction C of FIG. 3(a), and FIG. 3(c) is a cross-sectional view taken along the line C-C passing through points 105, 105 in FIG. 3(b) perpendicularly to a drill axis.

Cutting edges of the twist drill 130 shown in FIG. 3 comprise a chisel 101, center cutting edges 102 continuous to outer ends of the chisel 101, and almost linear main cutting edges 103 continuous outwardly to the respective center cutting edges 102. As shown in FIG. 3(b), the main cutting edge 103 is formed as a ridge line defined by a conical or planar flank 120, which has a point angle α101 and a relief angle on a leading edge 107, and a flute 106. The flute 106 has a shape formed of a combination of one or more arcs in the cross section, and when a particular point angle α101 is chosen, the main cutting edge 103 is almost linear. As shown in FIG. 3(c), therefore, a rake angle α103 of the flute 106 in the cross section is a positive angle, and the leading edge 107 defined by the flute 106 and a margin 109 form an acute angle α104 in the cross section.

When a drilling operation is carried out by using the twist drill of FIG. 3 without using cutting oil or with spraying of a very small amount of cutting oil to the drill, insufficient strength of the leading edge causes problems of rapid progression of wear of corner portions and breakage of the leading edge.

To minimize such wear and chipping of the corner portions and damage to the leading edge, a twist drill of FIG. 2 disclosed in JP-A-2000-198011 has been proposed. FIG. 2(a) is a plan view of a tip portion of the twist drill, FIG. 2(b) is a side view as viewed in a direction C of FIG. 2(a), and FIG. 2(c) is a cross-sectional view taken along the line C-C passing through points 205, 205 in FIG. 2(b) perpendicularly to a drill axis.

The cutting edges at the end of the twist drill 230 shown in FIG. 2 have a chisel 201, a pair of center cutting edges 202 continuous to outer ends of the chisel 201, a pair of almost linear main cutting edges 203 continuous outwardly to the respective center cutting edges 202, and corner cutting edges 204 receding at an angle from middle portions of the main cutting edges 203. An angle α204 of the leading edge 207 defined by a chamfered portion 208 and the margin 209 is set to an obtuse angle. The chamfered portion 208 is provided on the leading edge 207, which is defined by the flute 206 forming the main cutting edge 203 and the corner cutting edge 204 and by the margin 209, and has a linear or curved shape following the corner cutting edge 204. An angle formed by the chamfered portion 208 and an axial plane passing through the axis, a so-called rake angle α203, is set to a negative angle.

The conventional twist drill of JP-A-2000-198011 is suited for minimizing wear and chipping of corner portions and damage to leading edges in a drilling operation using no cutting oil, or a drilling operation with spraying of a very small amount of cutting oil to the drill, or in a drilling operation on relatively hard steel. However, in a drilling operation using cutting oil or in a drilling operation on relatively soft steel material such as general structural rolled steel and low-carbon steel, there are cases where cut chips are formed to extend along the chamfered portion 208 following the corner cutting edge 204 and cause chip choking.

### BRIEF SUMMARY OF THE INVENTION

An object of the invention is to provide a twist drill having cutting edges that minimize wear and chipping of corner portions and damage to leading edges in a drilling operation using no cutting oil, or a drilling operation with spraying of a very small amount of cutting oil to the drill, or in a drilling operation on relatively hard steel, and that have a function of facilitating breaking of cut chips into pieces during a drilling operation using cutting oil and during a drilling operation on steel of relatively low hardness such as general structural rolled steel and low carbon steel.

The invention attains the above object by providing a twist drill that allows a drilling operation using no cutting oil or a drilling operation with spraying of a very small amount of cutting oil to the drill, that may have no oil hole and that has the following features.

The twist drill comprises a drill body capable of rotation about an axis in a drill rotation direction, a pair of chip evacuating flutes formed in an outer peripheral surface of the drill body, a pair of chisels formed at an end of the drill body, a pair of center cutting edges continuous to outer ends of the chisels, a pair of main cutting edges having a centrally-concaved shape and continuous to the respective outer ends of the center cutting edges, and a pair of corner cutting edges linearly receding at an angle from the outer ends of the main cutting edges in a direction opposite to the drill rotation direction, wherein respective ends of the concave-shaped main cutting edges are situated on a straight line (O₁) almost parallel to a plane (O) passing through the axis, wherein chamfered portions of a linear shape following the corner cutting edges are provided on leading edges which are defined by the flutes and margins, the flutes defining the main cutting edges and the corner cutting edges, and wherein an angle of the leading edges which are formed by the chamfered portion and the margin is set to an obtuse angle.

As the twist drill of the invention has the pair of main cutting edges of the concave shape and continuous to the outer ends of the center cutting edges, and the pair of corner cutting edges receding at the angle from the outer ends of the main cutting edges in the direction opposite to the drill rotation direction, and as respective ends of the concave main cutting edges are situated on the straight line (O₁) almost parallel to the plane (O) passing through the drill axis, the centrally-concaved portions of the main cutting edges have a function of facilitating curling of chips and facilitating breakage into pieces. The pair of corner cutting edges linearly receding with respect to the drill rotation direction forms an obtuse angle with the leading edges to improve the corner strength and thus have a function of inhibiting damage to the corner portions when the drill is driven at high speed during a drilling operation using no cutting oil, during a drilling operation with spraying of a very small amount of cutting oil to the drill, during a drilling operation using cutting oil, or during a drilling operation on steel of relatively low hardness.

A radius of curvature of the centrally-concaved main cutting edges is preferably set to 25-40% of a diameter of the twist drill. If the radius of curvature is less than 25% of the twist drill diameter, the convex connection portions continuous to the main cutting edges have an angle too small so that the convex connection portions may be broken. If the radius of curvature exceeds 40% of the twist drill diameter, the curling performance of chips will deteriorate. It is also desired that the connection portions to the corner cutting edges are slightly rounded convex.

More preferably, the angle α1 of the corner cutting edges receding from the outer ends of the main cutting edges, i.e., the angle that the corner cutting edges have with respect to the parallel straight line (O₁), should be set to 5-20°. If the angle α1 is less than 5°, the corner portions have insufficient strength, and rapid corner wear will result during a drilling operation using no cutting oil or a drilling operation wherein a very small amount of cutting oil is sprayed to the drill. If the angle α1 exceeds 20°, chips will extend along the corner cutting edges and cause chip choking during a drilling operation using cutting oil.

A radial length of the corner cutting edges is preferably set to 7-15% of the twist drill diameter. If the radial length of the corner cutting edge exceeds 15% of the twist drill diameter, the range of the corner cutting edges becomes too large, and chips will extend along the corner cutting edges and cause chip choking. If the radial length of the corner cutting edge is less than 7% of the twist drill diameter, there is only little effect of minimizing damage to the leading edges.

### BRIEF DESCRIPTION OF THE SEVERAL VIEWS OF THE DRAWING

FIG. 1 is explanatory views showing an embodiment of a twist drill according to the invention, wherein FIG. 1(a) is a plan view of a tip portion of the twist drill, FIG. 1(b) is a side view of the twist drill as viewed in a direction C of FIG. 1(a), and FIG. 1(c) is a cross-sectional view of the twist drill taken along a line C-C of FIG. 1(b) perpendicularly to a drill axis.

FIG. 2 illustrates the tip portion of the conventional twist drill having the receding corner cutting edges, wherein FIG. 2(a) is the plan view of the tip portion, FIG. 2(b) is the side view of the tip portion as viewed in the direction C of FIG. 2(a), and FIG. 2(c) is the cross-sectional view of the drill taken along the line C-C of FIG. 2(b) perpendicularly to the drill axis.

FIG. 3 illustrates the tip portion of the other conventional twist drill having the linear cutting edges, wherein FIG. 3(a) is the plan view of the tip portion, FIG. 3(b) is the side view of the tip portion as viewed in the direction C of FIG. 3(a), and FIG. 3(c) is the cross-sectional view of the drill taken along the line C-C of FIG. 3(b) perpendicularly to the drill axis.

FIG. 4 shows the result of a cutting performance test carried out on example 1 of dry cutting, with an upper part thereof showing the shapes of cut chips and a lower part showing the number of holes drilled up to the end of drill life.

FIG. 5 shows the a result of a cutting performance test carried out on example 2 of wet cutting, with an upper part thereof showing the shapes of cut chips and a lower part showing the number of holes drilled up to the end of drill life.

### DETAILED DESCRIPTION OF THE INVENTION

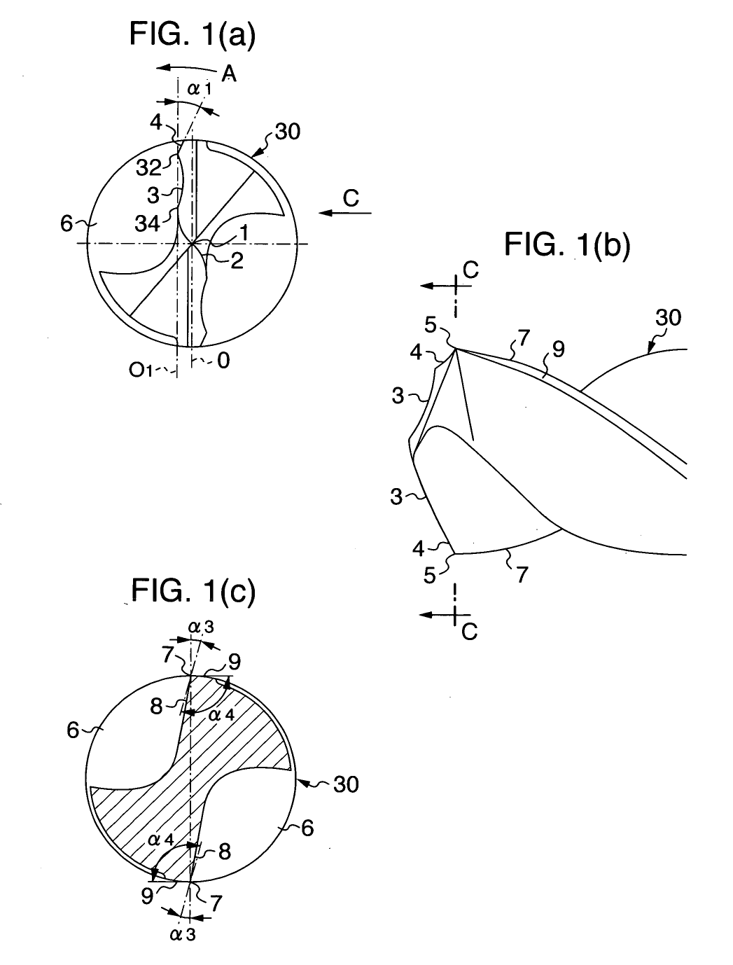

The best mode for carrying out the present invention or an embodiment thereof will be described with reference to FIG. 1.

FIG. 1 is the explanatory views showing the embodiment of the twist drill of the invention, wherein FIG. 1(a) is the plan view of the tip portion of the twist drill, FIG. 1(b) is the side view of the twist drill as viewed in the direction C of FIG. 1(a), and FIG. 1(c) is the cross-sectional view of the drill taken along the line C-C passing though points 5, 5 in FIG. 1(b) perpendicularly to the drill axis.

The twist drill in the best mode for carrying out the invention allows a drilling operation without using cutting oil or a drilling operation with spraying of only a very small amount of cutting oil to the drill. This twist drill may have no oil hole. The twist drill has a drill body 30 for rotation about the axis in the drill rotation direction, a pair of chip evacuating flutes 6 formed in an outer peripheral surface of the drill body 30, a pair of chisels 1 formed at an end of the drill body 30, a pair of center cutting edges 2 continuous to outer ends of the chisels 1, a pair of main cutting edges 3 having a centrally-concaved shape continuous outwardly to the respective center cutting edges 2, and a pair of corner cutting edges 4 receding at an angle α1 from outer ends of the main cutting edges 3 in a direction opposite to the drill rotation direction A.

Respective ends 32, 34 of the concave-shaped main cutting edges 3 are situated on a straight line (O₁) almost parallel to a plane (O) passing through the axis. A linear chamfered portion 8 following the corner cutting edge 4 is provided on a leading edge 7 formed by a margin 9 and the flute 6 that defines the main cutting edge 3 and the corner cutting edge 4. An angle α4 of the leading edge 7 formed by the chamfered portion 8 and the margin 9 is set to an obtuse angle.

With this construction, the centrally-concaved portions of the main cutting edges have a function of facilitating curling of chips and facilitating breaking them into pieces. The pair of corner cutting edges receding linearly with respect to the drill rotation direction have an obtuse angle with respect to the leading edges to improve the strength of the corner portions and have a function of minimizing damage to the corner portions when the drill is used at high speed either during a drilling operation using no cutting oil, a drilling operation with spraying of a very small amount of cutting oil to the drill, a drilling operation using a cutting fluid, or a drilling operation on steel of relatively low hardness.

In this embodiment of the invention, the radius of curvature of the concave main cutting edges is set to 25-40% of the diameter of the twist drill, with their connection portions to the corner cutting edges slightly rounded convex.

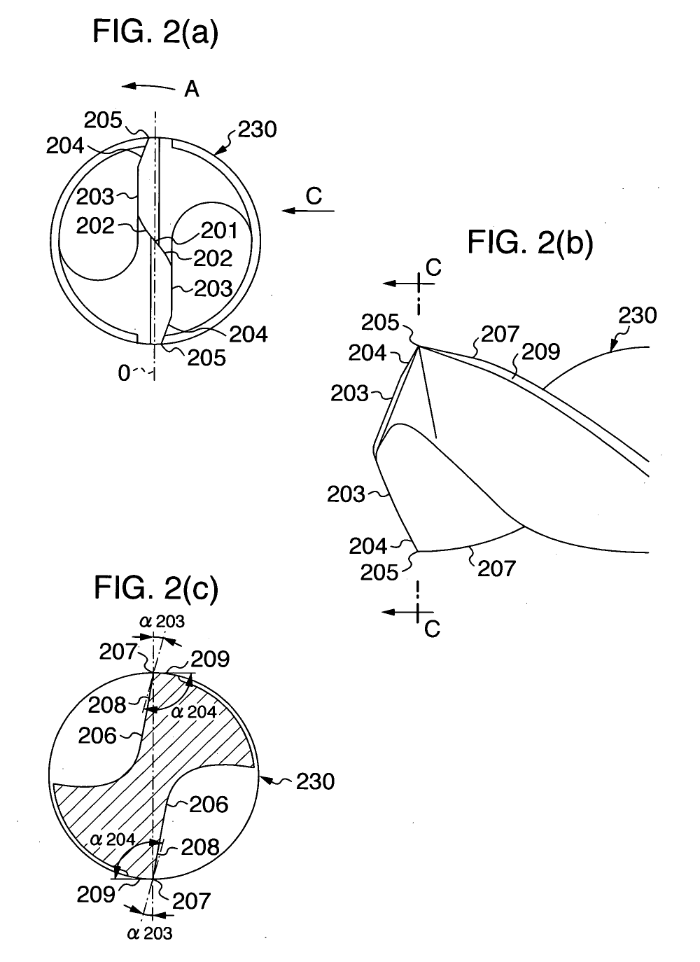

An angle α1 of the corner cutting edges 4 receding from the outer ends of the respective main cutting edges 3, i.e., the angle α1 that the corner cutting edges 4 form with respect to the parallel line (O₁), is set to 5-20°. A radial length of the center cutting edges 4 is set to 7-15% of the diameter of the twist drill and the angle α1 that the parallel line (O₁) makes relative to the center cutting edges 4 is set to 5-20°. Further, a rake angle α3 formed by the chamfered portions 8 and an axial plane is set to a negative angle, similarly to the conventional example of FIG. 2.

Although in this embodiment, the cutting edges of the twist drill are made of cemented carbide, a similar effect could also be obtained with high speed tool steel. By coating one layer or two or more layers of transition metals of 4a, 5a, or 6a group in the periodic table and of carbide, nitride, oxide or boride of 3b or 4b group over at least the tip portion of the twist drill by a thickness of 0.5-5 μm, the twist drill of a longer service life could be provided.

### EXAMPLE 1

As the drill of the invention having the main cutting edges 3 of the centrally-concaved shape, a twist drill of cemented carbide configured as shown in FIG. 1 was manufactured. This twist drill has an outer diameter of 6 mm, a total length of 72 mm, a flute length of 28 mm, a point angle of 140°, and a margin width of 0.4 mm. A radius of curvature of the concave-shaped main cutting edges is 30% of the drill diameter (1.8 mm in radius), with their connection portions with the corner cutting edges slightly rounded convex. A radial length of the corner cutting edges is 7% of the drill diameter (0.42 mm in length) and an angle α1, which the corner cutting edges make with respect to a straight line (O₁) parallel to a plane passing through the axis, is set to 10°.

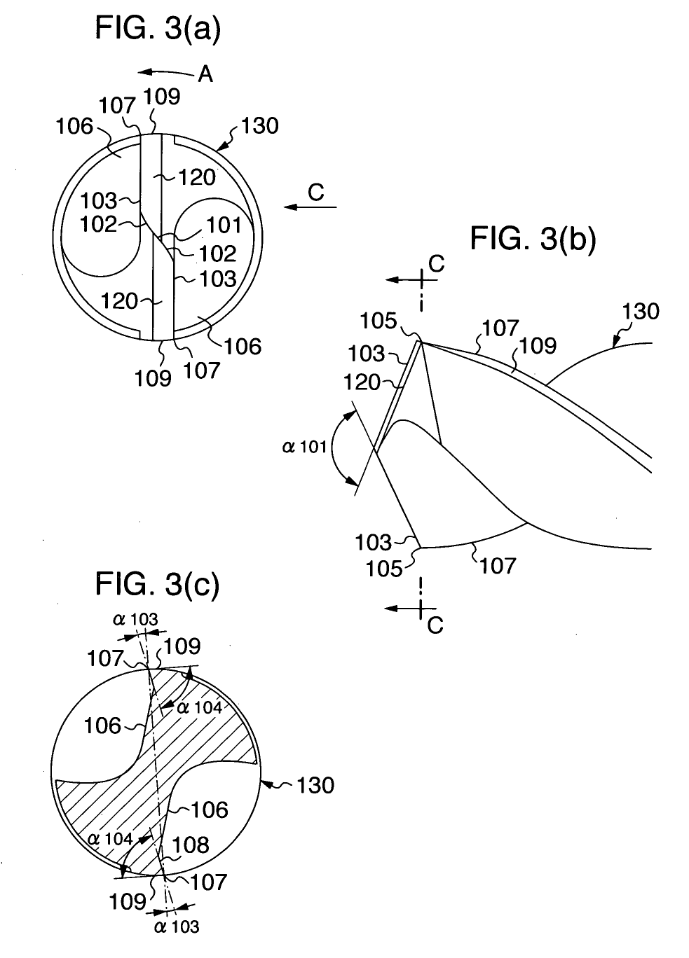

For comparison, a twist drill of cemented carbide as shown in FIG. 3 was manufactured which had an outer diameter of linear main cutting edges 103 of 6 mm, a total length of 72 mm, a flute length of 28 mm, a point angle of 140° and a margin width of 0.4 mm. Another twist drill of cemented carbide was also manufactured, which as shown in FIG. 2 had corner cutting edges 204 receding at an angle from middle portions of main cutting edges 203, with a radial length of the corner cutting edges 204 set to 7% of the drill diameter and with a receding angle α1 of the corner cutting edges 204 set to 10°.

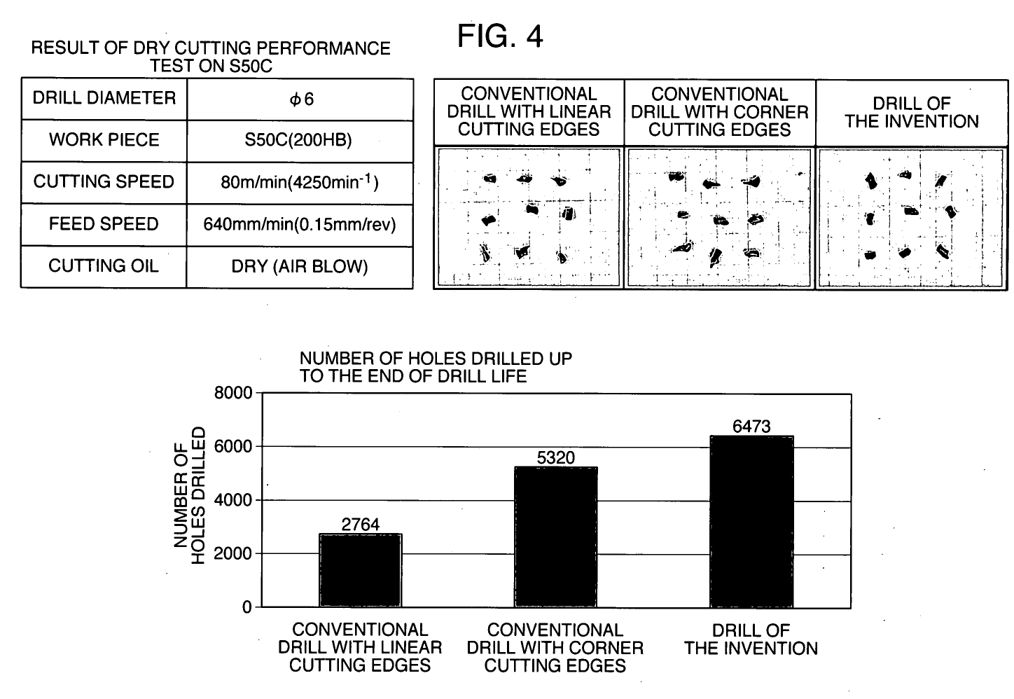

FIG. 4 shows the result a drilling test conducted as a dry cutting performance test using the drill of this invention, the conventional drill having the linear main cutting edges 103 shown in FIG. 3 and the conventional drill having the receding corner cutting edges 204 shown in FIG. 2. In the test, a work piece S50C (ISO No. C50) of 200HB was dry-drilled at a cutting speed of 80 m/min and a feed speed of 640 mm/min to a hole depth of 17 mm. The shapes of chips produced by the dry drilling and the number of holes drilled up to the ends of service life of the drills were checked. An upper part of the figure shows the shapes of chips and a lower part shows the number of holes drilled until the ends of service life.

As for the conventional twist drill with the linear cutting edges, although cut chips were broken in pieces, excess corner wear resulted in a short life. The conventional drill having the corner cutting edges produced similar shapes of chips to those produced by the conventional drill with the linear cutting edges, but had a longer life, i.e., the number of holes drilled up to the end of drill life was about 1.9 times larger. The twist drill of the invention had a longer life as compared with the conventional drill with the corner cutting edges and chips were also broken into pieces.

### EXAMPLE 2

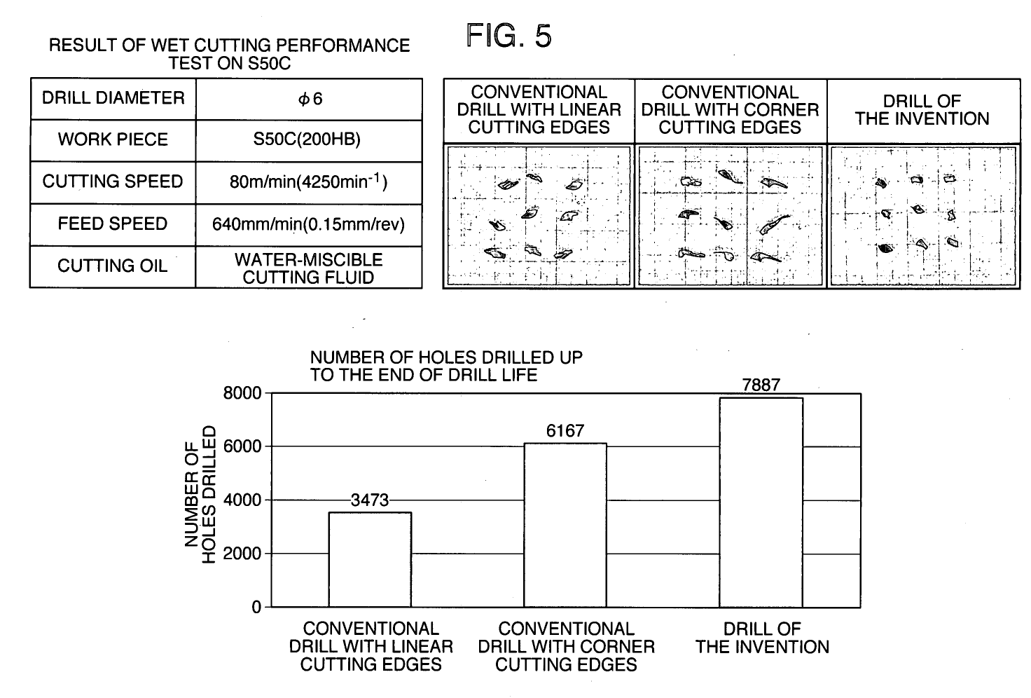

FIG. 5 shows the result of a drilling test conducted as a wet cutting performance test, similarly to the example 1, with use of the drill of the invention, the conventional drill having the linear main cutting edges 103 shown in FIG. 3 and the conventional drill having the receding corner cutting edges 204 shown in FIG. 2. In these wet cutting performance tests, a work piece S50C (200HB) was drilled at a cutting speed of 80 m/min and a feed speed of 640 mm/min to a hole depth of 17 mm with use of a water-soluble cutting fluid, and the shapes of chips produced and the number of holes drilled up to the ends of service life of the drills were investigated. An upper part of the figure shows the shapes of chips and a lower part shows the number of holes drilled until the ends of service life.

As for the conventional twist drill with the linear cutting edges, the chips formed were somewhat elongated and the number of holes drilled was small because of the progression of corner wear. The conventional drill with the corner cutting edges could drill about 1.7 times as many holes up to the end of drill life, but the chips formed were elongated. The drill of the invention could drill the largest number of holes and break chips into pieces and clearly exhibited the effect of breaking chips into small pieces by means of the centrally-concaved main cutting edges.

1. A twist drill allowing a drilling operation without using cutting oil or a drilling operation with spraying of a very small amount of cutting oil to the drill and capable of dispensing with an oil hole, comprising:
a drill body for rotation about an axis in a drill rotation direction;
a pair of chip evacuating flutes formed in an outer peripheral surface of the drill body;
a pair of chisels formed at an end of the drill body;
a pair of center cutting edges continuous to outer ends of the chisels;
a pair of main cutting edges having a concave shape and continuous outwardly to respective outer ends of the center cutting edges; and
a pair of corner cutting edges linearly receding at an angle from outer ends of the main cutting edges in a direction opposite the drill rotation direction,
wherein respective ends of the concave-shaped main cutting edges are situated on a straight line (O₁) almost parallel to a plane (O) passing through the axis, linear chamfered portions following the corner cutting edges are provided on leading edges which are formed by the flutes and margins, the flutes defining the main cutting edges and the corner cutting edges, and an angle of the leading edges which are formed by the chamfered portions and the margins is set to an obtuse angle.

2. A twist drill according to claim 1, wherein a radius of curvature of the concave-shaped main cutting edges is 25-40% of a diameter of the twist drill and their connection portions with the corner cutting edges are slightly rounded convex.

3. A twist drill according to claim 1, wherein a radial length of the corner cutting edges is 7-15% of a diameter of the twist drill.

4. A twist drill according to claim 2, wherein a radial length of the corner cutting edges is 7-15% of a diameter of the twist drill.

5. A twist drill according to claim 1, wherein an angle α1 of the corner cutting edges receding from the outer ends of the main cutting edges, namely the angle that the corner cutting edges make with respect to the parallel straight line (O₁), is 5-20°.

6. A twist drill according to claim 2, wherein an angle α1 of the corner cutting edges receding from the outer ends of the main cutting edges, namely the angle that the corner cutting edges make with respect to the parallel straight line (O₁), is 5-20°.

7. A twist drill according to claim 3, wherein an angle α1 of the corner cutting edge receding from the outer ends of the main cutting edges, namely the angle that the corner cutting edge makes with respect to the parallel straight line (O₁), is 5-20°.

8. A twist drill according to claim 4, wherein an angle α1 of the corner cutting edge receding from the outer ends of the main cutting edges, namely the angle that the corner cutting edge makes with respect to the parallel straight line (O₁), is 5-20°.

9. A twist drill according to claim 1, wherein the cutting edges of the twist drill are made of high speed tool steel or cemented carbide.

10. A twist drill according to claim 2, wherein the cutting edges of the twist drill are made of high speed tool steel or cemented carbide.

11. A twist drill according to claim 3, wherein the cutting edges of the twist drill are made of high speed tool steel or cemented carbide.

12. A twist drill according to claim 4, wherein the cutting edges of the twist drill are made of high speed tool steel or cemented carbide.

13. A twist drill according to claim 5, wherein the cutting edges of the twist drill are made of high speed tool steel or cemented carbide.

14. A twist drill according to claim 6, wherein the cutting edges of the twist drill are made of high speed tool steel or cemented carbide.

15. A twist drill according to claim 7, wherein the cutting edges of the twist drill are made of high speed tool steel or cemented carbide.

16. A twist drill according to claim 1, wherein at least tip portions of the cutting edges of the twist drill are coated with one layer or two or more layers of transition metals of 4a, 5a or 6a group in the periodic table and of carbide, nitride, oxide or boride of 3b or 4b group by a thickness of 0.5-5 μm.
